(19) United States
(12) Patent Application Publication
(10) Pub. No.: US 2025/0110432 A1
(43) Pub. Date: Apr. 3, 2025

(54) FIXING DEVICE CAPABLE OF MAKING NIP WIDTH UNIFORM IN WIDTH DIRECTION OF PRESSURE AREA

(71) Applicant: KYOCERA Document Solutions Inc., Osaka (JP)

(72) Inventors: Masakazu Uehara, Osaka (JP); Takuya Kawasumi, Osaka (JP); Tomohiro Watatani, Osaka (JP)

(21) Appl. No.: 18/900,182

(22) Filed: Sep. 27, 2024

(30) Foreign Application Priority Data
Sep. 28, 2023 (JP) 2023-168557

(51) Int. Cl. G03G 15/20

(52) U.S. Cl. CPC G03G 15/2053; G03G 15/2064; G03G 2215/2038

(57) ABSTRACT

A fixing device includes a heater holder, a stay, and a pressure roller. The fixing device press the stay toward the pressure roller to form a pressure area. The stay includes a pair of side plates. The heater holder includes pedestal ribs on which the pair of side plates are placed. The pair of side plates are formed such that center portions in the width direction protrude more toward the pressure area than both end portions. The pedestal ribs are higher at a center than at both ends in the width direction. In the fixing device, α−X−Y is set to a value close to zero, where an amount of protrusion of the side plates at a predetermined position in the width direction is X, a height of the pedestal ribs is Y, and an amount of deformation of the stay in the pressure area is α.

### INCORPORATION BY REFERENCE

This application is based upon and claims the benefit of priority from the corresponding Japanese Patent Application No. 2023-168557 filed on Sep. 28, 2023, the entire contents of which are incorporated herein by reference.

### BACKGROUND

The present disclosure relates to a fixing device that fixes a toner image on a sheet.

The fixing device includes a fixing belt heated by a heater, and a pressure roller. The heater is held by a heater holder and is in contact with the inner peripheral surface of the fixing belt to heat the fixing belt. The heater holder is reinforced by a stay. Both end portions of the fixing belt, the heater holder, and the stay in a sheet width direction are supported by an end holder. When the stay is pressed toward the pressure roller while being supported by the end holder, a pressure area is formed between the pressure roller and the fixing belt. When a sheet on which the toner image has been transferred passes through the pressure area, the toner image is heated and pressed to be fixed on the sheet.

In the fixing device having such a configuration, the both end portions of the stay are pressed toward the pressure roller; therefore, the center portion of the stay is deformed so that it curves toward the opposite side of the pressure roller. Then, the pressure applied from the stay to the fixing belt becomes non-uniform in the sheet width direction, and as a result, the nip width in the pressure area becomes non-uniform in the width direction, resulting in deterioration in the fixing performance and the conveying performance.

Accordingly, a fixing device is known in which the center portions of the side plates of the stay are formed to protrude more toward the pressure area than the both end portions. Accordingly, when the stay is pressed toward the pressure roller while being supported by the end holder, the surface of the stay on the pressure roller side becomes substantially straight, and the pressure applied from the stay to the fixing belt can be made uniform.

### SUMMARY

A fixing device of the present disclosure includes a fixing belt, a heater, a heater holder, a stay, an end holder, and a pressure roller. The fixing belt is endless and rotatable. The heater is in contact with the inner peripheral surface of the fixing belt. The heater holder holds the heater. The stay reinforces the heater holder. The end holder supports both end portions of the fixing belt, the heater holder, and the stay in the width direction of a sheet. The pressure roller is disposed to face the heater with the fixing belt interposed therebetween. The fixing device presses the stay toward the pressure roller while supporting the stay with the end holder so as to form a pressure area between the pressure roller and the fixing belt, in which the sheet on which a toner image has been transferred is heated and pressed. The stay includes a top plate and a pair of side plates. The pair of side plates are disposed to face each other in a direction intersecting the width direction of the sheet The heater holder includes a bottom plate and pedestal ribs. The bottom plate includes a recess for accommodating the heater. The pedestal ribs are provided on the bottom plate, and the pair of side plates of the stay are placed on the pedestal ribs. The pair of side plates of the stay are formed such that center portions in the width direction protrude more toward the pressure area than the both end portions The pedestal ribs of the heater holder are higher at a center than at both ends in the width direction. In the fixing device, α−X−Y is set to a value close to zero, where an amount of protrusion of the side plates of the stay at a predetermined position in the width direction is X, a height of the pedestal ribs of the heater holder is Y, and an amount of deformation of the stay in the pressure area is α.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a front view schematically showing an internal configuration of an image forming apparatus including a fixing device according to an embodiment of the present disclosure.

FIG. 2 is a side view showing the fixing device according to an embodiment of the present disclosure.

FIG. 3 is a front cross-sectional view showing the fixing device according to an embodiment of the present disclosure.

FIG. 4 is a perspective view showing a heater holder and a stay of the fixing device according to an embodiment of the present disclosure.

FIG. 5 is a cross-sectional view showing the heater holder and the stay of the fixing device according to an embodiment of the present disclosure.

FIG. 6 is a side view showing the stay of the fixing device according to an embodiment of the present disclosure.

FIG. 7 is a side view showing the stay, the heater holder and a pressure roller of the fixing device according to an embodiment of the present disclosure.

FIG. 8 is a graph showing an example of the relationship between the dimensional tolerance and the number of stays in the fixing device according to an embodiment of the present disclosure.

### DETAILED DESCRIPTION

Hereinafter, a fixing device according to an embodiment of the present disclosure will be described with reference to the drawings.

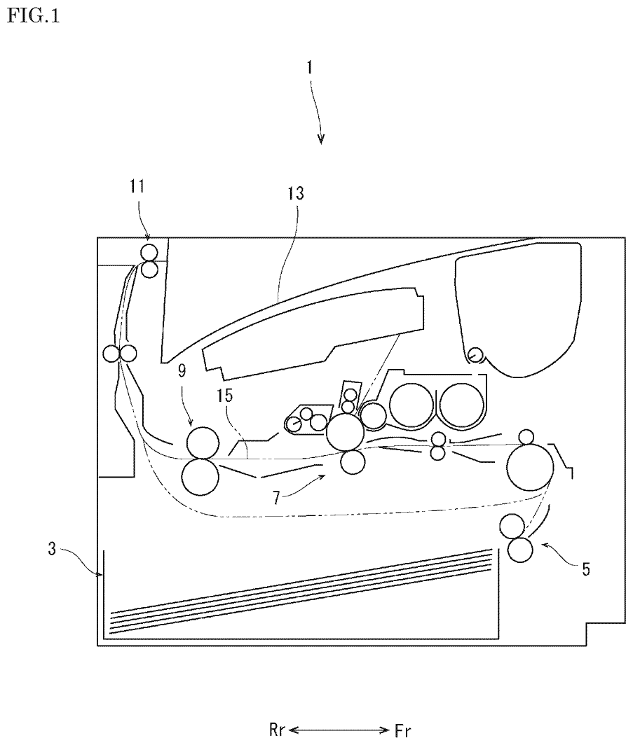

First, an image forming apparatus 1 including a fixing device 9 will be described with reference to FIG. 1. FIG. 1 is a front view schematically showing the interior of the image forming apparatus 1. Fr, Rr, L, and R in the figures indicate the front side, rear side, left side, and right side of the image forming apparatus 1, respectively.

The image forming apparatus 1 is provided with a sheet feed cassette 3 that stores a sheet, a sheet feed device 5 that feeds the sheet from the sheet feed cassette 3, an image forming portion 7 that forms a toner image on the sheet, a fixing device 9 that fixes the toner image onto the sheet, a sheet discharge device 11 that discharges the sheet, and a sheet discharge tray 13 on which the discharged sheet is stacked. Further, in the image forming apparatus 1, a conveying path 15 along which the sheet is conveyed from the sheet feed device 5 to the sheet discharge device 11 through the image forming portion 7 and the fixing device 9 is formed.

The sheet fed from the sheet feed cassette 3 by the sheet feed device 5 is conveyed to the image forming portion 7 along the conveying path 15, and a toner image is formed on the sheet at the image forming portion 7. The sheet on which the toner image has been formed is conveyed to the fixing device 9 along the conveying path 15, and the toner image is fixed onto the sheet at the fixing device 9. The sheet on which the toner image has been fixed is discharged to the sheet discharge tray 13 by the sheet discharge device 11.

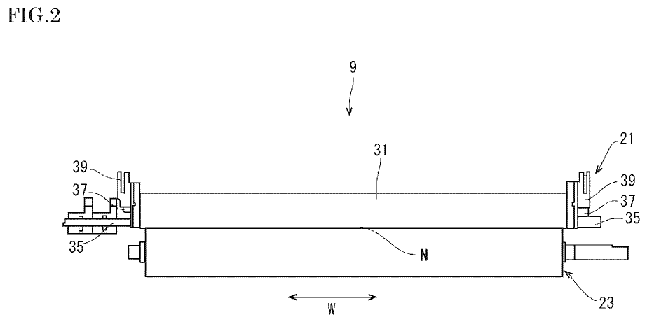

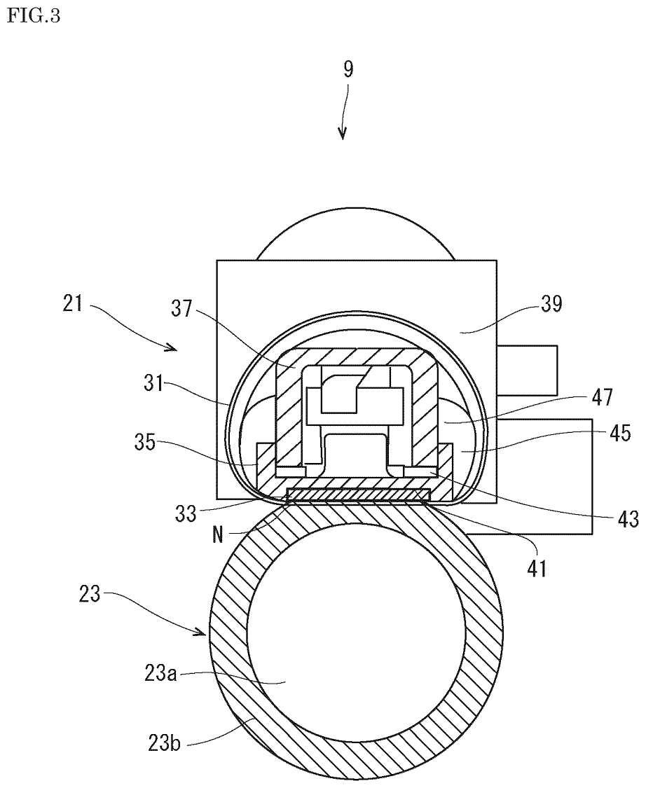

Next, the fixing device 9 will be described with reference to FIG. 2 and FIG. 3. FIG. 2 is a side view showing the fixing device 9 and FIG. 3 is a cross-sectional view showing the fixing device 9. The fixing device 9 includes a belt assembly 21 and a pressure roller 23. The belt assembly 21 and the pressure roller 23 are accommodated in a housing (not shown).

First, the belt assembly 21 will be described. The belt assembly 21 includes a fixing belt 31, a heater 33 (see FIG. 3) that heats the fixing belt 31, a heater holder 35 that holds the heater 33, a stay 37 that reinforces the heater holder 35, and an end holder 39 that supports both end portions of the fixing belt 31, the heater holder 35, and the stay 37 in a sheet width direction W.

In the fixing device 9, the stay 37 is pressed toward the pressure roller 23 while being supported by the end holder 39, thereby forming a pressure area N (see FIG. 2) between the pressure roller 23 and the fixing belt 31. When a sheet on which a toner image has been transferred passes through the pressure area N, the toner image is heated and pressed to be fixed on the sheet.

With such a configuration, both end portions of the stay 37 are pressed toward the pressure roller 23, the center portion of the stay 37 is deformed so that it curves toward the opposite side of the pressure roller 23. Then, the pressure applied from the stay 37 to the fixing belt 31 becomes non-uniform in the sheet width direction, and as a result, the nip width in the pressure area N becomes non-uniform in the width direction, resulting in deterioration in the fixing performance and the conveying performance.

Accordingly, a fixing device is known in which center portions of the side plates of the stay 37 are formed to protrude more toward the pressure area N than both end portions. Thus, when the stay 37 is pressed toward the pressure roller 23 while being supported by the end holder 39, the surface of the stay 37 on the pressure roller 23 side becomes substantially straight, and the pressure applied from the stay 37 to the fixing belt 31 can be made uniform.

However, in the above-described fixing device, the stay 37 may not always deform as desired depending on the variation and dimensional accuracy of the stay 37 or other parts such as the heater holder 35 and the end holder 39.

On the other hand, in the fixing device 9 according to the embodiment of the present disclosure, it is possible to make the nip width in the width direction of the pressure area N uniform as will be described below.

First, the fixing belt 31 will be described. The fixing belt 31 is an endless belt having a predetermined inner diameter and a width longer than the width of the sheet. The fixing belt 31 is made of a flexible material, and includes a base material layer, an elastic layer provided on the outer peripheral surface of the base material layer, and a release layer provided on the outer peripheral surface of the elastic layer. The base material layer is made of a metal such as SUS or Ni. The elastic layer is made of silicon rubber or the like. The release layer is made of a PFA tube or the like.

Next, the heater 33 will be described. The heater 33 is a flat planar heater and has a width equivalent to the width of the fixing belt 31 and a predetermined length and thickness. The heater 33 has a laminated structure in which a substrate made of stainless steel or ceramic, an electrically insulating layer made of glass, a resistance heating element layer having an electrode, and a protective layer are stacked in this order from the back side to the front side. The surface of the protective layer is flat and serves as a sliding surface that is in contact with the inner peripheral surface of the fixing belt 31. When the resistance heating element layer is energized through the electrode, the resistance heating element layer generates heat.

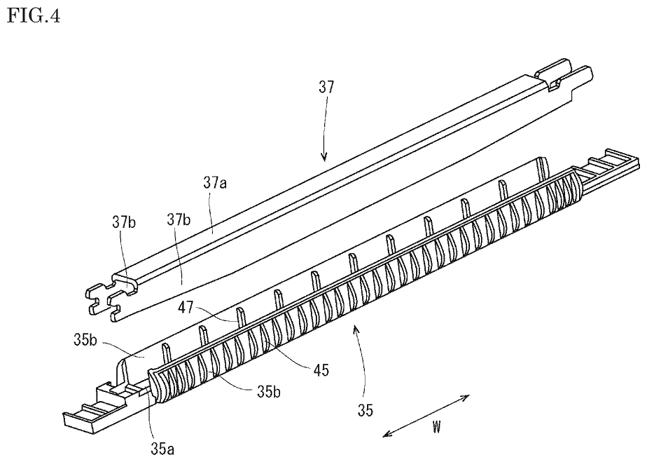

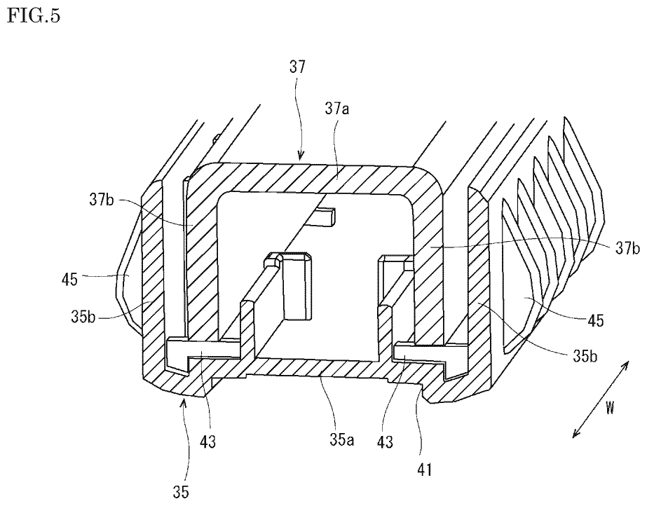

Next, the heater holder 35 will be described with reference to FIG. 4 and FIG. 5. FIG. 4 is a perspective view showing the heater holder 35 and the stay 37, and FIG. 5 is a cross-sectional perspective view showing the heater holder 35 and the stay 37.

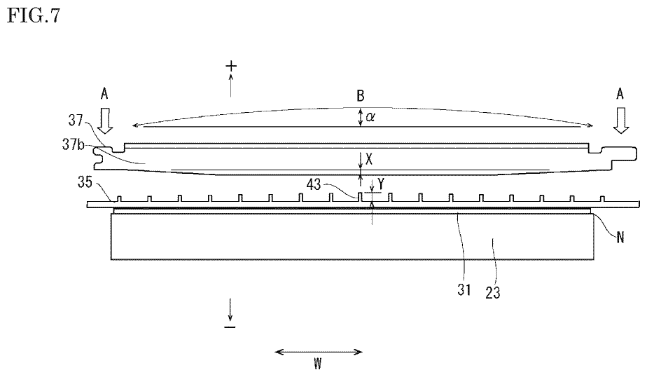

As shown in FIG. 4 and FIG. 5, the heater holder 35 is a member having a substantially U-shaped cross-section and including a bottom plate 35a and a pair of side plates 35b. The width of the heater holder 35 is longer than the widths of the fixing belt 31 and the heater 33. A recess 41 (see FIG. 5) for accommodating the heater 33 is formed in the outer surface of the bottom plate 35a. A plurality of pedestal ribs 43 are formed on the inner surface of the bottom plate 35a. The pedestal ribs 43 each have a rectangular parallelepiped shape having a predetermined length along an intersecting direction that intersects the sheet width direction and a predetermined height. The plurality of pedestal ribs 43 are disposed at both end portions of the inner surface of the bottom plate 35a in the intersecting direction at predetermined intervals in the width direction W. The pedestal ribs 43 are formed such that the height Y (see FIG. 7) is highest at the center portion in the width direction W and gradually decreases toward the both end portions. The height Y of the pedestal ribs 43 will be described later with reference to FIG. 7.

A plurality of guide ribs 45 are formed at predetermined intervals in the width direction W on the outer surfaces of the pair of side plates 35b. The guide ribs 45 each have a substantially semicircular shape along the circumferential direction of the fixing belt 31. Further, support ribs 47 (see FIG. 4) extending in the height direction of the side plates 35b are formed at predetermined intervals in the width direction W on the inner surfaces of the pair of side plates 35b.

As shown in FIG. 2, the heater holder 35 penetrates the hollow portion of the fixing belt 31, and both end portions thereof protrude outward from both sides of the fixing belt 31. The heater holder 35 is made of a heat-resistant resin such as a liquid crystal polymer.

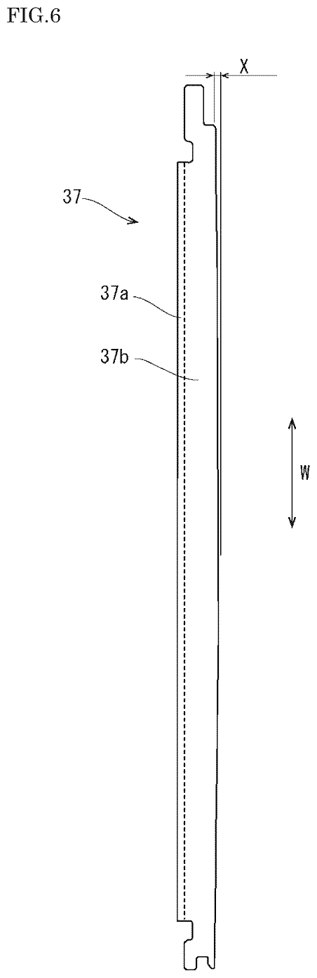

Next, the stay 37 will be described with reference to FIG. 4, FIG. 5, and FIG. 6. FIG. 6 is a cross-sectional view showing the stay 37. The stay 37 is a member having a substantially U-shaped cross-section and including a top plate 37a and a pair of side plates 37b. As shown in FIG. 6, the center portions of the pair of side plates 37b in the width direction W are formed to be higher than both end portions. In other words, the center portions of the pair of side plates 37b protrude more than the both end portions, and the amount of protrusion X is highest at the center portion and gradually decreases toward the both end portions. The width of the stay 37 is longer than the width of the fixing belt 31. The stay 37 is made of sheet metal and has a thickness of 2 mm. The amount of protrusion of the side plates 37b will be described later with reference to FIG. 7.

As shown in FIG. 5, the stay 37 is disposed between the side plates 35b of the heater holder 35 such that the opening between the pair of side plates 37b faces the opening between the side plates 35b of the heater holder 35. The side plates 37b of the stay 37 are supported by the support ribs 47 (see FIG. 4) of the heater holder 35, and the end surfaces of the side plates 37b are placed on the pedestal ribs 43 of the heater holder 35. As shown in FIG. 2, both end portions of the stay 37 protrude outward from both sides of the fixing belt 31.

Next, the end holder 39 will be described with reference to FIG. 2 and FIG. 3. The end holder 39 rotatably supports the both end portions of the fixing belt 31, and also supports the both end portions of the heater holder 35 and the stay 37 that protrude outward from the fixing belt 31.

Next, the pressure roller 23 will be described with reference to FIG. 2 and FIG. 3. The pressure roller 23 includes a core 23a and an elastic layer 23b provided on the outer peripheral surface of the core 23a. The elastic layer 23b is made of silicon rubber or the like. A release layer may be provided on the outer peripheral surface of the elastic layer 23b.

As described above, the belt assembly 21 and the pressure roller 23 are accommodated in a housing (not shown). The pressure roller 23 is rotatably supported between lower portions of a pair of side plates (not shown) of the housing. The pressure roller 23 is connected to a motor (not shown). The belt assembly 21 is disposed above the pressure roller 23, and the end holder 39 is supported by the upper portions of the pair of side plates of the housing. The heater 33 faces the pressure roller 23 with the fixing belt 31 interposed therebetween. The end holder 39 is urged toward the pressure roller 23 by a pressing plate and a coil spring (both of which are not shown). Specifically, the side plates 37b of the stay 37 urge the pedestal ribs 43 (bottom plate 35a) of the heater holder 35 toward the pressure roller 23. Thus, a pressure area N (see FIG. 2 and FIG. 3) is formed between the fixing belt 31 and the pressure roller 23.

A fixing operation of the fixing device 9 having the above-described configuration will be described. During the fixing operation, the pressure roller 23 is driven by a motor and rotates. Then, the fixing belt 31 is guided by the guide ribs 45 of the heater holder 35 and rotates in the opposite direction of the pressure roller 23, following the rotation of the pressure roller 23. Thus, the sheet to which the toner image has been transferred passes through the pressure area N. At this time, the toner image is heated and pressed to be fixed on the sheet.

An example of a method for setting the amount of protrusion of the center portions of the side plates 37b of the stay 37 and the height of the pedestal ribs 43 of the heater holder 35 will be described with reference to FIG. 7. FIG. 7 is a side view showing the stay 37, the heater holder 35, and the pressure roller 23. As described above, the center portions of the side plates 37b of the stay 37 protrude more toward the pressure area N (which is a − direction) than the both end portions. Further, the pedestal ribs 43 of the heater holder 35 are formed such that those at the center are the highest.

As described above, when the stay 37 is pressed toward the pressure roller 23 while being supported by the end holder 39 at the time of forming the pressure area N (see arrow A), the center portion of the stay 37 is deformed so as to curve in the opposite direction of the pressure roller 23 (which is a + direction) (see arrow B). In order to compensate for such deformation of the stay 37, the center portions of the side plates 37b of the stay 37 are protruded toward the pressure roller 23, and the pedestal ribs 43 at the center of the heater holder 35 are formed to be higher than those at the ends.

Here, the amount of deformation of the center portions of the side plates 37b of the stay 37 is α, the amount of protrusion of the center portions of the side plates 37b of the stay 37 is X, and the height of the pedestal ribs 43 at the center portion of the heater holder 35 is Y Then, the center portions of the side plates 35b of the stay 37 protrude toward the pressure area N (in the − direction) by the amount of α−X−Y when the pressure area N is formed. For example, when the amount of protrusion is larger than 0.39 mm (when the center portions of the side plates 37b of the stay 37 protrude toward the pressure area N), the nip width of the pressure area N changes in the width direction W. Therefore, at the time of forming the pressure area, it is necessary to set the center portions of the side plates 37b of the stay 37 not to protrude toward the pressure area N as much as possible, that is, to make the value of α−X−Y as close to zero as possible.

The amount of deformation a generally depends on the rigidity of the stay 37. In the present disclosure, since the thickness of the stay 37 is 2 mm, the maximum amount of deformation a is set to +0.148 mm to +0.173 mm. The amount of protrusion X of the center portions of the side plates 37b of the stay 37 is set to −0.1 mm. In addition, the dimensional tolerance of the pedestal ribs 43 of the heater holder 35 is set to ±0.05 mm. In order to make the value of α−X−Y zero as much as possible, the height Y of the pedestal rib 43 at the center is 0.22±0.05 mm. In this case, the nip width in the pressure area N is maintained within a desired range in the width direction W.

As described above, by setting the amount of protrusion of the center portions of the side plates 37b of the stay 37 and the height of the pedestal ribs 43 of the heater holder 35, even when the dimensional tolerance of the stay 37 and heater holder 35 are considered, the protrusion of the center portions of the side plates 37b of the stay 37 toward the pressure area N is suppressed at the time of forming the pressure area N and the nip width of the pressure area N can be made uniform in the width direction W. In particular, by setting the thickness of the stay 37 to 0.2 mm, the deformation of the stay 37 at the time of forming the pressure area N can be suppressed. Accordingly, even in the fixing device 9 configured to press the stay 37 toward the pressure roller 23 while supporting the stay 37 with the end holder 39 so as to form the pressure area N, it is possible to make the nip width of the pressure area N uniform in the width direction W and stabilize the fixing performance and the conveying performance.

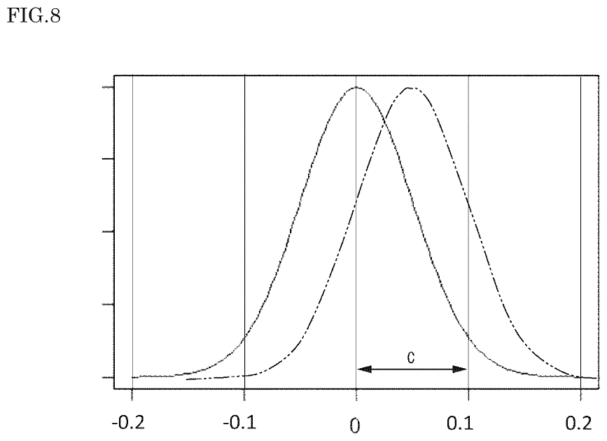

Next, the dimensional tolerance of the stay 37 will be described with reference to FIG. 8. In the graph of FIG. 8, the horizontal axis indicates the dimensional tolerance, and the vertical axis indicates the number of stays 37. It is assumed that the dimensional tolerance of the stay 37 due to machining appears in the normal distribution indicated by the solid line in the graph. When the amount of protrusion of the center portions of the side plates 37b of the stay 37 is 0 to 0.1 mm, the stays 37 included in the range indicated by arrow C in the graph are used. In this case, when the center portions of the side plates 37b of the stay 37 are made convex by 0.05 mm, the dimensional tolerance of the stay 37 due to machining shifts to the normal distribution indicated by the two dot chain line in the graph. As a result, since the number of the stays 37 included in the range indicated by arrow C can be increased, the probability that the nip width can be made uniform in the width direction W can be increased as described above.

In the present embodiment, the thickness of the stay 37 is set to 2 mm to suppress deformation, but the stay 37 may be provided with a reinforcing rib along the width direction W to suppress deformation.

Further, the above description of the embodiment of the present disclosure is intended to describe a preferred embodiment of the present disclosure, and therefore, various technically preferable limitations may have been added, but the technical scope of the present disclosure is not limited to these aspects unless there is a description that particularly limits the present disclosure.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A fixing device comprising:
a rotatable endless fixing belt;
a heater in contact with an inner peripheral surface of the fixing belt;
a heater holder configured to hold the heater;
a stay configured to reinforce the heater holder;
an end holder configured to support both end portions of the fixing belt, the heater holder, and the stay in a width direction of a sheet; and
a pressure roller disposed to face the heater with the fixing belt interposed therebetween, wherein
the fixing device presses the stay toward the pressure roller while supporting the stay with the end holder so as to form a pressure area between the pressure roller and the fixing belt, in which the sheet on which a toner image has been transferred is heated and pressed,
the stay includes:
a top plate; and
a pair of side plates disposed to face each other in a direction intersecting the width direction of the sheet,
the heater holder includes:
a bottom plate including a recess for accommodating the heater; and
pedestal ribs on the bottom plate on which the pair of side plates of the stay are placed,
the pair of side plates of the stay are formed such that center portions in the width direction of the pair of side plates of the stay protrude more toward the pressure area than the both end portions,
the pedestal ribs of the heater holder are higher at a center than at both ends in the width direction,
α−X−Y is set to a value close to zero, where an amount of protrusion of the side plates of the stay at a predetermined position in the width direction is X, a height of the pedestal ribs of the heater holder is Y, and an amount of deformation of the stay in the pressure area is α.

2. The fixing device according to claim 1, wherein
a maximum value of the amount of protrusion X of the side plates of the stay is 0.1 mm.

3. The fixing device according to claim 2, wherein
a thickness of the stay is 2 mm.
